(19) United States
(12) Patent Application Publication
(10) Pub. No.: US 2017/0080586 A1
(43) Pub. Date: Mar. 23, 2017

(54) Cutting Apparatus

(71) Applicant: Donald Kenneth Bunnell, St. Joseph, MI (US)

(72) Inventor: Donald Kenneth Bunnell, St. Joseph, MI (US)

(21) Appl. No.: 14/734,305

(22) Filed: Jun. 9, 2015

(51) Int. Cl. B26D 1/20; B26D 1/00

(52) U.S. Cl. CPC B26D 1/205; B26D 1/0006; B26D 2001/0066

(57) ABSTRACT

A rotary cutter apparatus uses an improved geometrical arrangement of parts to optimize cutter speed versus evenness and straightness of cut, increase operating life and quietness of operation, and reduce dust formation and energy consumption.

### CROSS-REFERENCES TO RELATED APPLICATIONS

This non-provisional application for patent claims priority to copending PCT Application No. PCT/US10/55792, published as Publication No. WO 2012/064320, which is incorporated herein in its entirety.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A BIOLOGICAL SEQUENCE LISTING

Not applicable.

### BACKGROUND OF INVENTION

Field of the Invention

This invention is in the field of cutters, more specifically in the field of cutters with intersecting blades, and still more specifically in the field of motor-driven cutters of sheet material.

Description of the Related Art

Many consumable products are manufactured in the form of spirally-wound rolls, e.g., paper towels and gift wrap. While these products can be unwound from the roll entirely by hand, there are a number of devices in the prior art to aid in dispensing product from the roll. These range from simple support of the roll, such as a single upright spindle upon which the axis of the roll is vertically installed, to cabinets into which a product roll is placed and which have mechanisms for dispensing product.

For simplicity of further discussion, and because the most common product roll dispensed is paper or similar nonwoven web material, the terms “paper,” “paper towel” and “paper towel roll” will be used hereinafter instead of “product” and “product roll.” However, it should be understood that the present invention can be adapted to virtually any spiral-wound sheet product.

Until the issue of U.S. Pat. No. 6,994,408 to the present inventor, a problem with dispensers of the art prior to U.S. Pat. No. 6,994,408 was that parts driven at high speed were stopped by surfaces, such as bumpers, in the machine, which led to excessive noise and impact wear.

The cutting mechanism of that device is a circular blade slicing product along a horizontal linear blade. The circular blade rotates on an axle that moves in a direction parallel to the linear blade, with its axle tilted so that the leading edge of the circular blade is higher than the trailing edge. The rotation of the circular blade causes the leading edge of the circular blade to rotate toward the linear blade. In other words, if the circular blade is beneath the linear blade and the axle of the circular blade is moving from right to left, the upper end of the axle is tilted to the right, the leading edge of the circular blade is tilted upward, and the product is sheared against the linear blade.

The circular blade is made to rotate by an o-ring mounted on the same axle which presses against a fixed horizontal surface parallel to the linear blade. The function of cutting paper with the rotary cutter method is affected by a combination of variables including the angle of attack of the circular blade, the hardnesses of the blades, the pressure between the blades, the pressure of the o-ring against the horizontal surface, and the spinning speed of the circular blade. After thousands of tests, data show that the instant invention offers superior durability and repeatability, and that any one change can alter performance dramatically.

The reason for tilting the axle relative to the direction of travel originally was to prevent binding of the paper between the blades and galling of the blades. The reason for using a resilient o-ring to drive the cutter was to reduce noise and allow the drive mechanism to skid at that point and to assure consistent forward motion of the cutter without stripping its toothed rubber drive belt. Since issuance of that patent, these basic configurations have been validated, but they have been refined by extensive experimentation.

### BRIEF DESCRIPTION OF THE INVENTION

### Objects of the Invention

Needs addressed by the present invention are reduction in operating noise and vibration, improved resistance to cutter edge wear, reduction in dust formation, and improved operating life.

### SUMMARY OF THE INVENTION

The present invention is a rotary cutter apparatus that optimizes cutter speed versus evenness and straightness of cut, operating life, quietness of operation, and low dust formation. These and other benefits will become more clearly illustrated in the following detailed description and drawings.

### BRIEF DESCRIPTION OF THE DRAWINGS

FIG. 1 is an oblique view from the upper left front of a product roll cutter containing the present invention as it operates during the leftward pass of the cutting sequence.

FIG. 2 is a simplified oblique view of the key parts of the present invention operating in the same orientation as depicted in FIG. 1.

FIG. 3 is a top view of the key parts shown in FIG. 2.

FIG. 4 is a diagram of the geometry of the key parts shown in FIG. 3.

FIG. 5 is a left end view of the key parts shown in FIG. 2.

FIG. 6 is a front view of the key parts shown in FIG. 2.

### DETAILED DESCRIPTION OF THE INVENTION

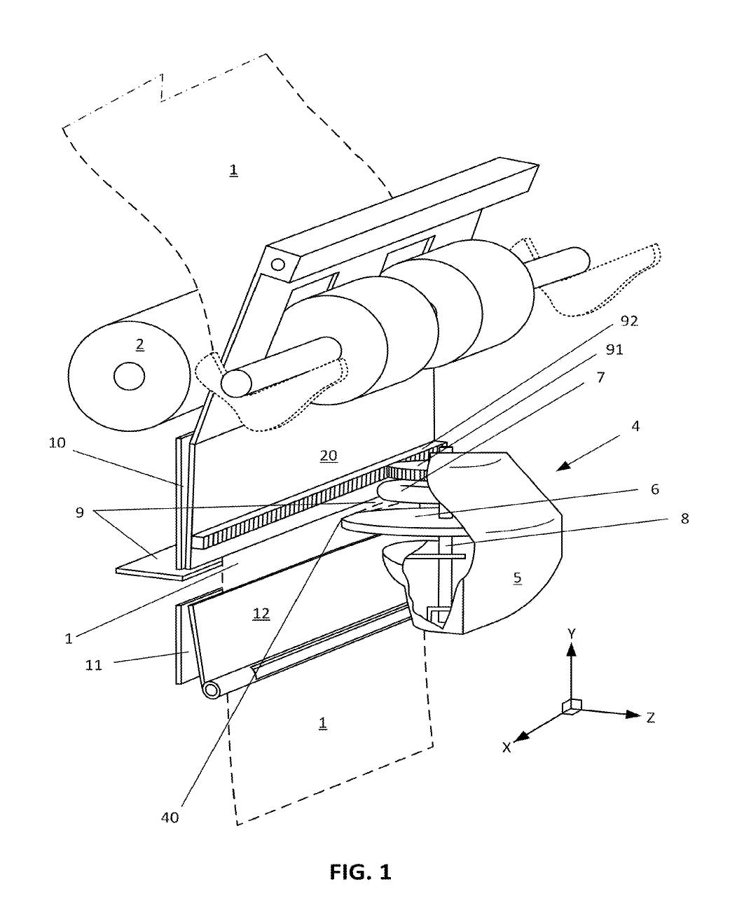

Referring now to the attached drawings, in which like features are represented by like reference characters in each of the drawings, FIG. 1 is an oblique view from the upper left front of the product roll cutter as described in copending PCT Application No. PCT/US10/55792 by the same inventor. A product roll of paper 1 has been advanced by drive roller 2 to the position shown. A cutter carousel 4 is shown in the process of cutting paper 1 from right to left in this drawing. Its case 5 is cut away to show a circular paper cutting blade 6, an optional pinion 91, and a rubber o-ring 7 mounted on a cutter dowel pin 8. Hereafter in the present application, the term “carousel,” unless otherwise specified, minimally consists of circular paper cutting blade 6, either pinion 91, rubber o-ring 7 or both, all rotatably mounted on a cutter dowel pin 8, and all held at a fixed orientation with respect to X, Y, and Z axes but movable along the X axis.

The features and description of this patent application are also to be understood to include the mirror image of what is described, that is, what enables building the invention from the instant description is also intended to enable building its mirror image. For example, carousel motion from right to left causing clockwise circular blade rotation as viewed from above expressly includes carousel motion from left to right causing counterclockwise circular blade rotation as viewed from above.

An upper pinch plate 20 in a substantially vertical plane, an optional rack 92 fixed to upper pinch plate 20, and an upper backing plate 10 are also shown. Upper pinch plate 20 and upper backing plate 10 function to grip paper 1 above a stationary horizontal straight cutting blade 9. A lower backing plate 11 and a lower pinch plate 12 function likewise to grip paper 1 below straight blade 9.

Carousel 4 is moved horizontally left and right by a belt (not shown) driven by an electric cut motor (not shown) as described in PCT Application No. PCT/US10/55792. As carousel 4 moves to the left, the rubber o-ring 7 contacts the upper pinch plate 20. Upper pinch plate 20 is pushed rearward by the rubber o-ring 7, pinching the paper 1 against the upper backing plate 10. Friction of the o-ring 7 against the upper pinch plate 20 drives the circular paper cutting blade 6 clockwise (as viewed from above) about the cutter dowel pin 8. Optionally, a pinion 91 may be installed upon the cutter dowel pin 8, for the purpose of engaging an optional rack 92 fixed to the front side of the upper pinch plate 20 to provide positive forced rotation of the circular blade 6 about the cutter dowel pin 8.

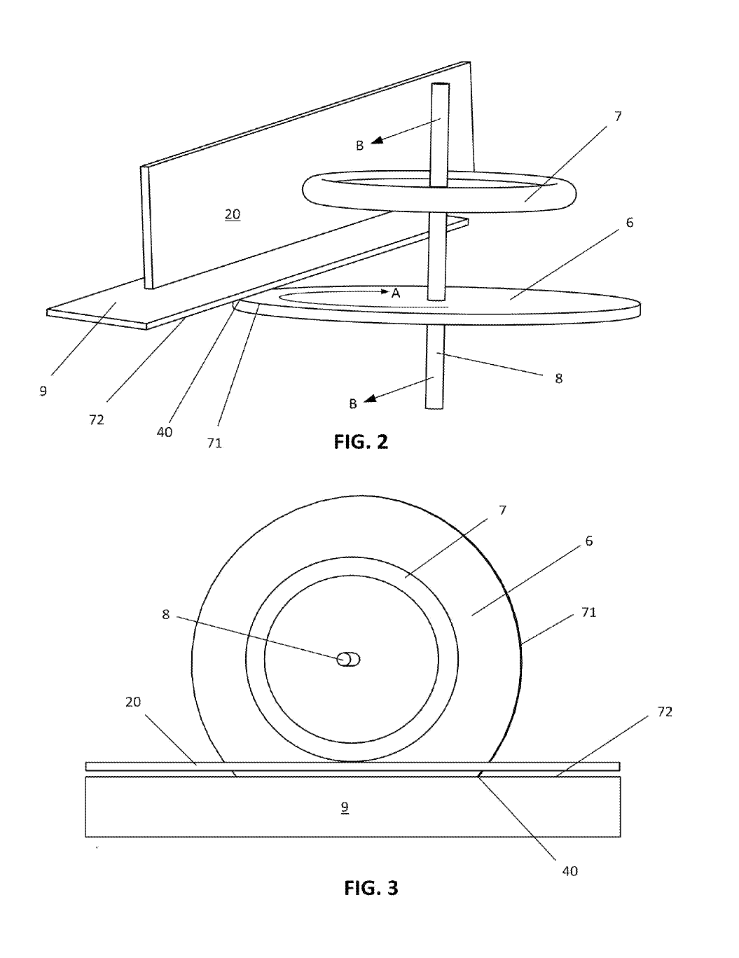

FIG. 2 is a simplified oblique view of the key parts of the present invention operating in the same orientation as depicted in FIG. 1. The key parts are: circular blade 6, o-ring 7, and cutter dowel pin 8 about which they rotate (the “carousel”); upper pinch plate 20; and straight blade 9. Circular blade 6 has a circular cutting edge 71, and straight blade 9 has a straight cutting edge 72. The point where the cutting edges meet, the cutting point 40, is of course where the paper is cut. FIG. 2 shows circular blade 6 rotating clockwise in path A, contacting straight blade 9 from below and moving from right to left in direction B. It is within the scope of this invention for circular blade 6 to contact straight blade 9 from above, rotate counterclockwise, and move from left to right.

Important Characteristics of the Present Invention:

I. The Net Velocity of the Point of Contact of the Circular Blade with the Straight Blade in the Horizontal Direction Must be Approximately Zero.

FIG. 3 is a top view of the parts shown in FIG. 2. Pinch plate 20 needs to be approximately vertical to allow for slight variations in the path of contact between it and o-ring 7. Although pinch plate 20 need not be precisely vertical, it is shown that way in this and the remaining drawings for better visualization and explanation of the relative orientation of the parts. In FIG. 3, the vertical direction is pointing out of the page, and the carousel, namely circular blade 6, o-ring 7, and cutter dowel pin 8 are all being driven from left to right in the horizontal direction by a drive belt (not shown). Because o-ring 7 is being pressed against stationary pinch plate 20, the rotational speed (in rpm) of dowel pin 8 is the same as that of o-ring 7. PCT Application No. PCT/US10/55792 by the present inventor states that because the rubber o-ring 7 is of smaller diameter than circular blade 6, the edge of the circular blade 6 is forced to move relative to straight blade 9 (leftward in FIG. 3) adding a (leftward) shear component to what would otherwise be a purely downward (in FIG. 3) shear component against the paper, and that these two effects produce a clean cut and minimize the creation of paper dust. However, the fact that o-ring 7 is of smaller diameter than circular blade 6 does not necessarily result in a slicing action parallel to straight blade 9. Further experimentation has shown that a leftward (or rightward) component of motion at the point of contact 40 can cause the sheet product to bunch, tearing the sheet or producing an uneven cut, and/or can cause the blades to separate and jam because of product being forced in between them. As it happens, the left and right components of velocity of contact point 40 in the present invention approximately cancel each other (so that the blades approach each other along a vertical line in this view) only if the sum of the o-ring radius plus the length of the normal from the stationary blade to the circular blade edge equals the radius of the circular blade. This is proven by the following calculations.

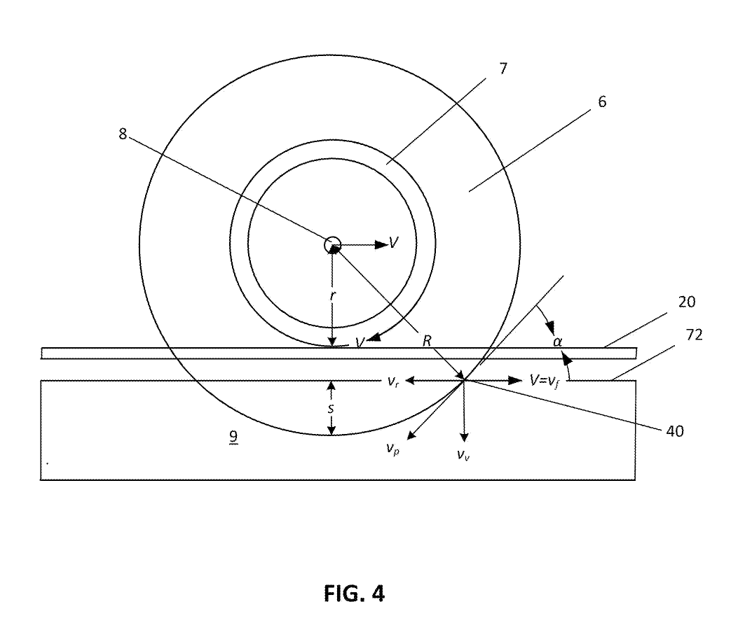

FIG. 4 is a diagram of the geometry of the blades of FIG. 3 under the simplifying assumption that the circular blade 6 and the o-ring 7 are both coplanar with straight blade edge 72, in which case the left and right components exactly cancel, as follows:
Forward (rightward) horizontal velocity of dowel pin 8 and point 40=v_{f}=V;
peripheral velocity of point 40=vₚ=VR/r; and
reverse horizontal velocity of point 40=vᵣ=vₚ(R−s)/R=(VR/r)(R−s)/R=V(R−s)/r.
For v_{f}=vᵣ, V=V(R−s)/r;
   therefore R=r+s.

This means that point 40 will move exclusively downwardly (in this view) across straight blade edge 72 only if blade edge 72 coincides with front surface of upper pinch plate 20. This fact, in combination with test results to arrive at the optimal circular blade and o-ring radii (see item II. following) further define the optimum geometry represented by the present invention. (In some models of this invention, the upper pinch plate 20, which o-ring 7 rides on, is closer to the axle 8 than the horizontal blade 72 by a small distance as shown in FIG. 3 to allow for the sheet product to hang between the back of the pinch plate and the horizontal blade. Unless the pinch plate is shaped to allow a larger o-ring radius, this small distance will cause a small net leftward component in the motion of the circular blade edge 71 at point 40.

II. Other Cutter Parameters are Necessary to Produce a High-Quality Cut and Protect Cutter Durability.

A high transverse speed of the cutter carousel is desirable for a fast cut, but it must be limited to control impact forces and noise. Experimentation by the inventor has shown that for these reasons, the optimum left-to-right speed V of the cutter (as shown in FIG. 4) should not exceed about 0.6 m/s. A circular blade radius R of 18.5 mm was chosen as the maximum for a reasonably compact assembly. Experimentation showed that unexpectedly superior cut quality, machine durability, reduced noise and minimal dust production were produced by using an o-ring radius r of 11.4 mm (61.6% of the circular blade radius) and observing the geometry described in item I. above. The corresponding calculations are given in Table 1 below:

TABLE 1

| | | |
|---|---|---|
| Cutter Forward Travel | T (Chosen by experiment) | 475 |
| Time, ms | | |
| Cutter Travel Distance, | D (Measured on machine) | 286 |
| mm | | |
| Maximum Horizontal | V = D/1000T | 602 |
| Cutter Velocity, mm/s | | |
| Maximum Circular Blade | R (Chosen by experiment) | 18.5 |
| Radius, mm | | |
| Maximum O-Ring | r (Chosen by Experiment) | 11.4 |
| Radius, mm | | |
| Optimum Ratio of O- | r/R | 0.616 |
| Ring Radius to Circular | | |
| Blade Radius | | |
| Cutter Assembly | S = 60 V/2πr | 504 |
| Rotation Speed, rpm | | |
| Cut Angle (Angle of | α = 180cos⁻¹(r/R)/π | 52 |
| Tangent to Circular Blade | (see FIG. 4) | |
| at Cut Point relative to | | |
| Straight Blade), Degrees | | |
| Velocity of Cut Point on | Vᵥ = Vπ(sin(α))/180) | 474 |
| Circular Blade | (see FIG. 4) | |
| Perpendicular to Straight | | |
| Blade, mm/s | | |

III. The O-Ring Diameter Must be Large Enough Not to Skid Against Upper Pinch Plate.

As shown in FIG. 1, circular blade 6 could be driven by a pinion 91 engaging a rack 92 rather than, or in addition to, an o-ring 7 frictionally engaging upper pinch plate 20. Even though the rack-and-pinion is an embodiment of the present invention, the o-ring drive option is the preferred embodiment. Two of the reasons the inventor chose to drive circular blade 6 with a resilient o-ring 7 rather than a pinion is (i) less noise and (ii) less potential damage in the event the blades seize. If a rubber o-ring alone is used to drive circular blade 6 (as it is in the preferred embodiment) the rolling friction between the rubber and the pinch plate must be less than the sliding friction to assure that the o-ring dependably rolls rather than skids along the pinch plate.

For a given force W of the o-ring against the plate, the sliding or dynamic frictional force F_{d} necessary to initiate skidding is F_{d}=f_{d}W, where f_{d} is the dynamic friction factor for rubber against the upper pinch plate material. The dynamic friction factor is used instead of the static friction factor because (as described in copending PCT Application No. PCT/US 10/55792) o-ring 7 begins spinning upon first contact with the right-hand edge of upper pinch plate 20, before it presses the pinch plate rearwardly in the machine, and it is therefore already rotating as it begins rolling along the vertical surface of the pinch plate 20. Estimates of the dynamic friction factor range from 0.5 (see http://www.tribology-abc.com/abc/cof.htm) to 3-4 (see http://nvlpubs.nist.gov/nistpubs/jres/28/jresv28n4p439_Alb.pdf), an average of 2.0 (dimensionless). The rolling frictional force Fᵣ necessary to initiate rolling is Fᵣ=fᵣW/r, where r is the radius of the o-ring and fᵣ is the rolling friction factor for the o-ring against the pinch plate (expressed in length units). An estimate of this is 0.0077 meters, or 7.7 mm (see www.roymech.co.uk/Useful_Tables/Tribology/co_of_frict.htm#coef). To assure that rolling will occur instead of skidding, Fᵣ<F_{d}, or fᵣW/r<f_{d}W Interestingly, the force W of the o-ring against the plate cancels out. Rearranging, r>fᵣ/f_{d}>7.7 mm/2.0=3.8 mm. Thus, by this measure, the radius of the o-ring r must be greater than about 4 mm to prevent skidding. The optimal o-ring radius selected by experiment as given in Table 1 is 11.4 mm, so the minimum radius of the o-ring is not limiting in the design of the cutter.

IV. The Shape of the Cutting Edges Should be Right Angles.

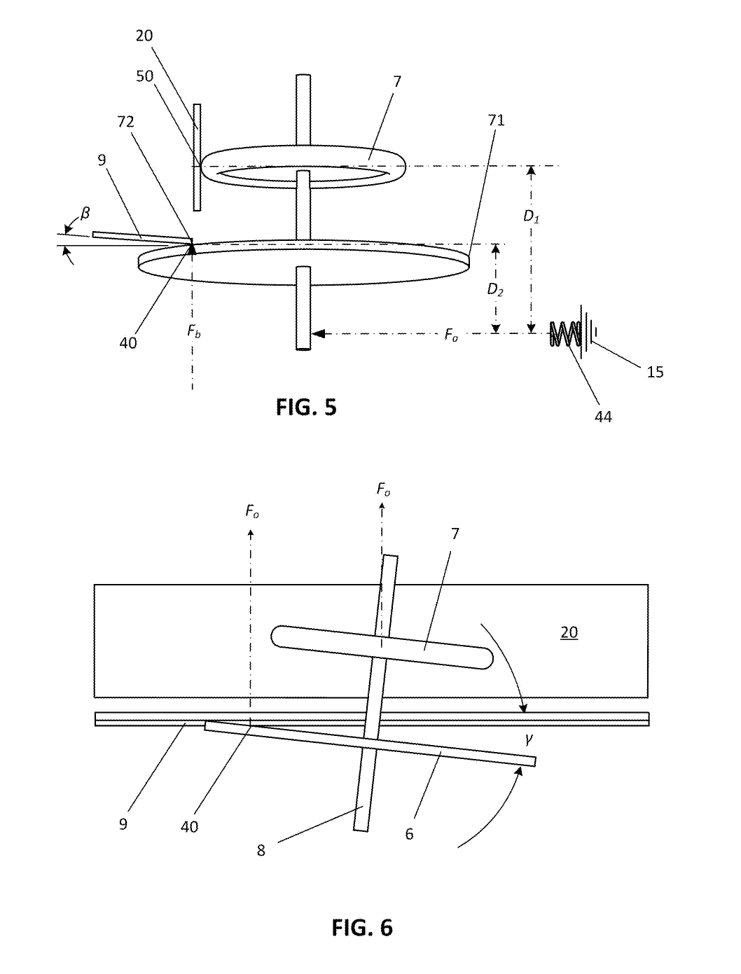

In FIG. 5 it can be seen that the cross-sections of cutting edges 71 and 72 are the vertices of right angles. The reason for this is that an acute angle on either blade is more prone to chipping, spalling, and earlier dulling. An obtuse angle is undesirable simply because it is less sharp and tends to pinch and tear the sheet rather than cutting it. This creates an uneven cut and dust.

V. Other Criteria are Necessary to Enable Self-Sharpening.

FIG. 3 is a top view of the parts shown in FIG. 2. Although pinch plate 20 need not be precisely vertical, it is shown that way in this illustration and in FIGS. 5 and 6 for better visualization and explanation of the relative orientation of the parts. As mentioned in PCT Application No. PCT/US10/55792, the experimentation done by the inventor at that time found that cutting action is enhanced by tilting the stationary paper cutting blade 9 downward toward the front of the invention (toward the right in FIG. 5) by about 5 degrees (angle β) and by inclining circular blade 6 clockwise (angle γ in FIG. 6) in a range of about 3 to 7 degrees. More recent testing has expanded this range to between 2 and 7 degrees.

Further experimentation has borne this out, but shows that the hardness of straight blade 9 is critical and must be set to 52 Rockwell C minimum. (Harder materials may be used but are more expensive.) Moreover, if straight blade 9 is harder than circular blade 6 by at least 4 Rockwell C points, it becomes self-sharpening. The vertex of the right angle at straight cutting edge 72 at cutting point 40 (like any real-world knife edge) is not a geometric point but a rounded edge, that is, a quarter circle of an extremely small radius. The softer metal of circular blade 6 actually maintains the rounded edge of straight cutting edge 72 at the expense of metal loss at circular cutting edge 71 provided the contact angle β is no greater than about 5 degrees, and angle γ is no greater than about 7 degrees. An angle greater than 5 degrees increases the incidence of galling on the circular cutting edge 71 (that is, the softer metal forming small lumps that adhere to and distort the edge rather than dissipating as an aerosol). An angle greater than 7 degrees significantly increases the carousel drive motor power requirement. (Note that these angles are low and do not materially affect the calculations in items I-III above.) From the standpoint of cut quality and dust production, it is more important that the straight cutting edge 72 remain perfectly straight than that the circular cutting edge 71 be perfectly round. The round blade will cut paper even if it is slightly uneven in radius provided cutting edge 71 remains planar.

VI. The Tilt of the Cutter Carousel Must be Within a Certain Range to Control the Shear Pressure Between the Blades and Minimize the Power Consumption.

It is important to maintain adequate upward pressure between circular blade 6 and straight blade 9 to prevent the blades from separating and becoming jammed because of uncut product being forced in between them. PCT Application No. PCT/US10/55792 teaches placing two springs at the end of a carousel track to bias the cutter carousel rearwardly and upwardly. FIG. 5 in the present application shows a force diagram in which the springs (represented here by spring 44 anchored within support structure 15) exert a horizontal force Fₐ against the carousel which not only drives o-ring 7 but also produces upward force F_{b} on circular blade 71 by virtue of lever arms D₁ and D₂ acting about the fulcrum of o-ring contact point 50. This upward force F_{b} is reduced by the ratio of the o-ring radius r to circular blade radius R. (Specifically, F_{b}=Fₐ(D₁r)/R(D₁-D₂)). The upward force F_{b} created by the springs is augmented by an upward pull Fₐ on circular blade 6 caused by the tilt of the o-ring drive mechanism, better shown in FIG. 6. Upward pull Fₐ is also a function of the force Fₐ pressing o-ring 7 against upper pinch plate 20 and the clockwise inclination (see angle γ in FIG. 6) of o-ring 7. Angle γ makes o-ring 7 “walk upwardly” against upper pinch plate 20 as it travels from right to left across it, and the greater the angle, the greater the upward pull. The upward pull at cutting point 40 is the same force Fₐ because cutter dowel pin 8 is constrained by its bearings within the carousel housing.

The spring bias Fₐ in FIG. 5 has been set by experiment so that the combination of spring upward force F_{b} and o-ring upward force Fₐ produces the best cut if angle γ is about 5 degrees. Angle γ can be below this range if the bias of spring 44 is increased, but experimentation has shown that it must not be less than 2 degrees. A lesser angle causes fouling between circular blade 6 and straight blade 9. An angle γ over 7 degrees requires too much power, the excess of which is more than necessary to roll the o-ring and merely grinds the circular blade against the straight blade after the sheet product is cut.

The same principles apply if, in embodiments, a rack-and-pinion mechanism is used with, or instead of, the o-ring system. However, the more dependence is placed on the rack-and-pinion, the greater the bias of the springs 44 needs to be above that of the preferred embodiment to achieve the necessary pressure between the blades. If the o-ring is eliminated, the effective diameter of the pinion teeth must be equal to the diameter of the o-ring in accordance with Table 1, and the upper pinch plate must be moved rearwardly in the unit to allow for the thickness of the rack.

1. A cutting apparatus, comprising:
an elongate straight blade,
having a forward facing, left-to-right horizontal cutting edge;
the horizontal cutting edge lying in a vertical first plane;
a circular blade having a circular cutting edge rotatable in a second plane; and
having an axis of rotation perpendicular to the second plane;
the axis moveable from left to right and back in a vertical third plane parallel to the first plane;
the third plane being a first horizontal distance forwardly from the first plane;
the circular cutting edge having a radius greater than the first horizontal distance;
the second plane intersecting the horizontal cutting edge at an angle in the first plane;
the horizontal cutting edge having a first point along it which coincides with a second point on the circular cutting edge, at which point sheet material is sheared; and
a means for rotating the circular blade about the axis to produce a tangential speed of the circular cutting edge and a linear speed of the axis in the third plane;
the motion of the first point relative to the second point in the left-right direction being within about 3% of the linear speed of the axis in the third plane.

2. The apparatus of claim 1, in which:
said means for rotating said circular blade is a carousel wherein said means for rotating the circular blade is driven coaxially about said axis by motion of said carousel left-to-right.

3. The apparatus of claim 2, wherein:
said means for rotating the circular blade is either:
(a) a resilient edge in frictional contact with a left-to-right elongate surface; or
(b) a shaped, rigid edge in contact with a shaped, left-to-right elongate surface; or
(c) both.

4. A cutting apparatus, comprising:
a first blade mounted horizontally left to right with a linear cutting edge;
a second blade with a circular cutting edge mounted in a carousel;
the plane of the circular cutting edge tilted at an angle to the horizontal so that the first and second blades come into contact at a single point, at which point sheet material is sheared; and
a means for moving the second blade along the first blade and rotating the second blade so that the relative motion of the linear cutting edge and the circular cutting edge at the point has substantially no horizontal component.

5. The cutting apparatus of claim 4, comprising:
a case having X, Y, and Z mutually-perpendicular axes in which said first blade is fixed to the case along the X axis;
a motor for moving said carousel along the X axis at a first speed;
said means for moving said second blade comprises:
an axle to which said second blade is fixed at its center to rotate perpendicularly about the axle; and
a linkage between the case and said carousel, constructed so that the tangential speed of said second blade is proportional to the first speed.

6. The cutting apparatus of claim 5, in which:
said linkage is a wheel fixed at its center to said axle, the rim of which positively engages a part of said case parallel to said first blade;
said angle is between about 2 and about 7 degrees; and
said first speed is no greater than about 2.0 feet per second.

7. The cutting apparatus of claim 6, in which:
the ratio of the radius of said wheel to the radius of said second blade is between about 0.60 and about 0.64.

8. The cutting apparatus of claim 7, in which:
the angle between the tangent of said circular cutting edge in said plane of said circular cutting edge and said linear cutting edge at said point is no less than about 45 degrees.

9. The cutting apparatus of claim 8, wherein:
said linear cutting edge has a Rockwell C hardness of at least about 52; and
said circular cutting edge has a Rockwell C hardness of no greater than about 48.

10: The cutting apparatus of claim 9, wherein:
said wheel is a resilient material for which the ratio of rolling friction factor to sliding friction factor against smooth polymeric material is no less than about 11 millimeters.

11. The cutting apparatus of claim 9, wherein:
said wheel is a pinion and said part of said case is a rack.

12. The cutting apparatus of claim 9, in which:
said linear cutting edge has a right angle cross-section that is tilted about 5 degrees clockwise as viewed from the left end.

13. A cutting apparatus, comprising:
an elongate stationary horizontal cutting edge lying in a first vertical plane;
having a right end and a left end; and
a Rockwell C hardness of at least about 48; and
an axle for turning a circular cutting edge;
the axle lying in a second plane which is parallel to, and separated perpendicularly from, the first vertical plane by between about 11.2 mm and 11.6 mm;
means for moving the axle right and left in the second plane;
the rightward velocity being between about 400 and 600 mm/second;
a circular cutting edge of Rockwell C hardness of at least about 52;
lying in a third plane perpendicular to the second plane;
having a center;
being fixed at its center to the axle;
having a radius from the centerline of the axle of no greater than about 18.5 mm; and
the axle being tilted within the second plane to raise the rightward edge of the circular blade to establish an axle tilt angle between the third plane and a horizontal plane;
the tilt angle being at least 2 degrees and no greater than 7 degrees;
establishing a point of contact with the horizontal cutting edge; and
the axle comprising means for rotating the circular edge at a peripheral velocity proportional to the rightward velocity so that the leftward component of peripheral velocity at the point of contact is substantially the same as the rightward peripheral velocity.

14. The cutting apparatus of claim 13, in which:
said means for moving said axle right and left and said means for rotating said circular edge are driven by a common motor.

15. The cutting apparatus of claim 13, in which:
said means for rotating said circular edge is either:
(a) an o-ring mounted on said axle, having a radius in the range of about 11.2 mm to 11.4 mm, in frictional contact with a left-to-right elongate surface; or
(b) a pinion mounted on said axle, having an effective radius in the range of about 11.2 mm to 11.4 mm, in contact with a mating left-to-right elongate rack; or
(c) both.

16. The cutting apparatus of claim 15, in which:
said elongate stationary horizontal cutting edge has a right angle cross-section that is tilted about 5 degrees clockwise as viewed from the left end.
